(19) United States
(12) Patent Application Publication
(10) Pub. No.: US 2007/0153170 A1
(43) Pub. Date: Jul. 5, 2007

(54) Method of fabricating pixel structure

(76) Inventor: Chi-Wen Yao, Gueishan Township (TW)

Correspondence Address: J.C. Patents, Inc., Suite 250, 4 Venture, Irvine, CA, 92618, US

(21) Appl. No.: 11/407,538

(22) Filed: Apr. 19, 2006

(30) Foreign Application Priority Data
Jan. 2, 2006 (TW) 95100041

(51) Int. Cl. G02F 1/1335

(52) U.S. Cl. 349/113

(57) ABSTRACT

A method of fabricating a pixel structure is provided. A scan line, a data line and an active device electrically connected to the scan line and the data line are formed over a substrate. A dielectric layer is formed over the substrate, and then a patterned photoresist layer is formed thereon. The patterned photoresist layer has first recesses and a first through hole that exposes a portion of the dielectric layer. A portion of the dielectric layer is removed using the patterned photoresist layer as an etching mask to form a patterned dielectric layer. The patterned dielectric has second recesses and a second through hole that exposes a portion of the active device. The patterned photoresist layer is removed and a reflective layer is formed on the patterned dielectric layer. The reflective layer covers the second recesses and electrically connects to the active device.

### CROSS-REFERENCE TO RELATED APPLICATION

This application claims the priority benefit of Taiwan application serial no. 95100041, filed on Jan. 2, 2006. All disclosure of the Taiwan application is incorporated herein by reference.

### BACKGROUND OF THE INVENTION

1. Field of the Invention

The present invention relates to a method of fabricating a pixel structure. More particularly, the present invention relates to a method of fabricating a pixel structure for a transflective liquid crystal panel (LCD) or a reflective LCD panel.

2. Description of Related Art

Most thin film transistor liquid crystal display devices are commonly classified as belonging to one of three major types, namely, the transmissive type, the reflective type and the transflective type. This classification is based on the utilization of the light source and the difference in the array substrate. The transmissive type of thin film transistor liquid crystal display (transmissive TFT-LCD) uses a back light source. The pixel electrodes on the thin film transistor array substrate are transparent electrodes to facilitate the penetration of light from the back light source. the reflective thin film transistor liquid crystal display (reflective TFT-LCD) uses a front light source or an external light source as the light source. The pixel electrodes on the thin film transistor array substrate are metal electrodes or other reflective electrodes with good reflection properties suitable for reflecting the light from the front light source or the external light source. On the other hand, the transflective thin Film transistor liquid crystal display (transflective TFT-LCD) can be regarded as a structure that integrates both the transmissive TFT-LCD and the reflective TFT-LCD. In other words, the transflective TFT-LCD is capable of utilizing both the back light source and a front light source or an external light source simultaneously in displaying images.

FIGS. 1A through 1D are schematic cross-sectional views showing the method for fabricating a reflective liquid crystal display according to U.S. Pat. No. 6,490,019. A conventional reflective type liquid crystal display can be fabricated according to the following steps. First, as shown in FIG. 1A, a first insulating layer 50 is formed on a substrate 10. Next, a gate 52 is formed on the first insulating layer 50. As shown in FIG. 1B, a second insulating layer 54 is formed on the first insulating layer 50 to cover the gate 52. Thereafter, a semiconductor layer 57 is formed on the second insulating layer 54 above the gate 52. The semiconductor layer 57 includes a channel layer 56 and an ohmic contact layer 58 disposed thereon.

As shown in FIG. 1C, a source 60 and a drain 62 are formed on the ohmic contact layer 58. Next, a passivation layer 64 is formed over the substrate 10 to cover the source 60 and the drain 62. thereafter, a portion of the passivation layer 64 is removed to form a contact hole 63. The contact hole 63 exposes a portion of the drain 62. Alter that, the first insulating layer 50, the second insulating layer 54 and the passivation layer 64 are etched to form a plurality of concave portions 66a. The method of forming the concave portions 66a includes performing a dry etching process.

Because the passivation layer 64 has an etching rate that differs from the first insulating layer 50 and the second insulating layer 54, the concave portions 66a has a tapering shape. Since the first insulating layer 50 increases the time required to form the concave portions 66a, the passivation layer 64 is subjected to a longer etching period. In other words, the concave portions 66a will have a smoother tapering profile.

As shown in FIG. 1D, a reflective electrode 68 is formed on the passivation layer 64. The reflective electrode 68 covers the surface of the concave portions 66a. The reflective electrode 68 is electrically connected to the drain 62 through the contact hole 63. Because the concave portions 66a have a smooth tapering profile, the reflective electrode 68 is still broken easily.

Although the aforementioned U.S. Pat. No. 6,490,019 can actually reduce the formation of breaks in the reflective electrode 68, an additional step for forming the first insulating layer 50 is needed in the fabrication process. Moreover, the possibility of having a break in the reflective electrode 68 still exists due to the deeper depth of the concave portions 66a despite its smother surface.

### SUMMARY OF THE INVENTION

Accordingly, at least one objective of the present invention is to provide a method of fabricating a pixel structure suitable for a transflective liquid crystal display panel or a reflective liquid crystal display panel.

To achieve these and other advantages and in accordance with the purpose of the invention, as embodied and broadly described herein, the invention provides a method of fabricating a pixel structure comprising the following steps. First, a substrate is provided. Then, a scan line, a data line and an active device are formed over the substrate. The active device is electrically connected to the scan line and the data line. A dielectric layer is formed on the substrate to cover the active device and the data line. Then, a patterned photoresist layer is formed on the dielectric layer. The patterned photoresist layer has a first through hole and a plurality of first recesses , wherein the first through hole exposes a portion of the dielectric layer. A portion of the dielectric layer is removed using the patterned photoresist layer as an etching mask to form a patterned dielectric layer. Tile patterned dielectric layer has a second through hole and a plurality of second recesses, wherein the second through hole exposes a portion of the active device. The patterned photoresist layer is removed and a reflective layer is formed on the patterned dielectric layer. The reflective layer covers the second recesses and electrically connects to the active device.

According to one embodiment of the present invention, the method of forming the patterned photoresist layer includes using a half-tone mask.

According to one embodiment of the present invention, the method of removing a portion of the dielectric layer includes performing a dry etching or a wet etching process.

According to one embodiment of the present invention, the reflective layer also covers the second through hole and electrically connects to the active device through the second through hole.

According to one embodiment of the present invention, a transparent conductive layer is formed on the patterned dielectric layer after removing the patterned photoresist layer but before forming the reflective layer. The transparent conductive layer covers the second through hole and the second recesses. Furthermore, (lie reflective layer is electrically connected to the active device through the transparent conductive layer. Moreover, the reflective layer has an opening that exposes a portion of the transparent conductive layer.

According to one embodiment of the present invention, a transparent conductive layer is formed on the patterned dielectric layer after removing the patterned photoresist layer but before forming the reflective layer. Furthermore, the transparent conductive layer is electrically connected to the active device through the reflective layer. Moreover, the reflective layer has an opening that exposes a portion of the transparent conductive layer.

According to one embodiment of the present invention, a transparent conductive layer is formed on the reflective layer after forming the reflective layer. The transparent conductive layer covers the second through hole. Furthermore, the reflective layer is electrically connected to the active device through the transparent conductive layer. Moreover, the reflective layer has an opening and the transparent conductive layer covers the opening.

According to one embodiment of the present invention, the method of forming the scan line, the data line and the active device includes forming a scan line and a gate connected to the scan line over the substrate. Then, a gate insulation layer is formed on the substrate to cover the gate. Thereafter, a semiconductor layer is formed on the gate insulation layer above the gate. After that, a data line and a source/drain connected to the data line are formed over the substrate. The source/drain is disposed on the semiconductor layer on the respective sides of the gate. In addition, the aforementioned second through hole exposes a portion of the source/drain.

Accordingly, the present invention uses a half-tone mask to form a patterned photoresist layer with the first through hole and the first recesses. Then, a dry etching or a wet etching for the dielectric layer is performed using the patterned photoresist layer as a mask to form the second through hole and the second recesses. As a result, a better control over the depth and profile of the second recesses is obtained.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIGS. 1A through 1D are schematic cross-sectional views showing the method for fabricating a reflective liquid crystal display according to U.S. Pat. No. 6,490,019.

FIGS. 2A through 2F are schematic cross-sectional views showing the method for fabricating a pixel structure according to a first embodiment of the present invention.

FIG. 2G is a schematic cross-sectional view showing another method of fabricating a pixel structure according to the first embodiment.

FIG. 3 is a top view of pixel structure shown in FIG. 21F.

FIGS. 4A and 4B are schematic cross-sectional views showing the method for fabricating a pixel structure according to a second embodiment of the present invention.

FIGS. 4C and 4D are schematic cross-sectional views showing another method for fabricating a pixel structure according to the second embodiment of the present invention.

FIG. 5 is a top view of the pixel structure shown in FIG. 4B.

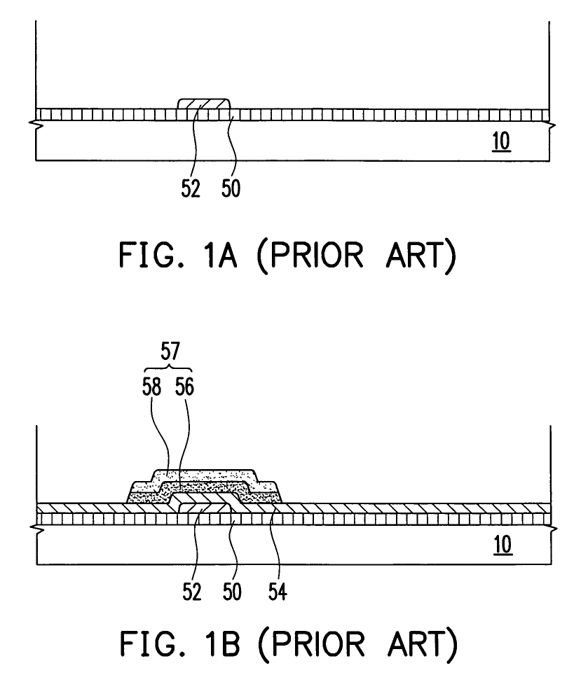

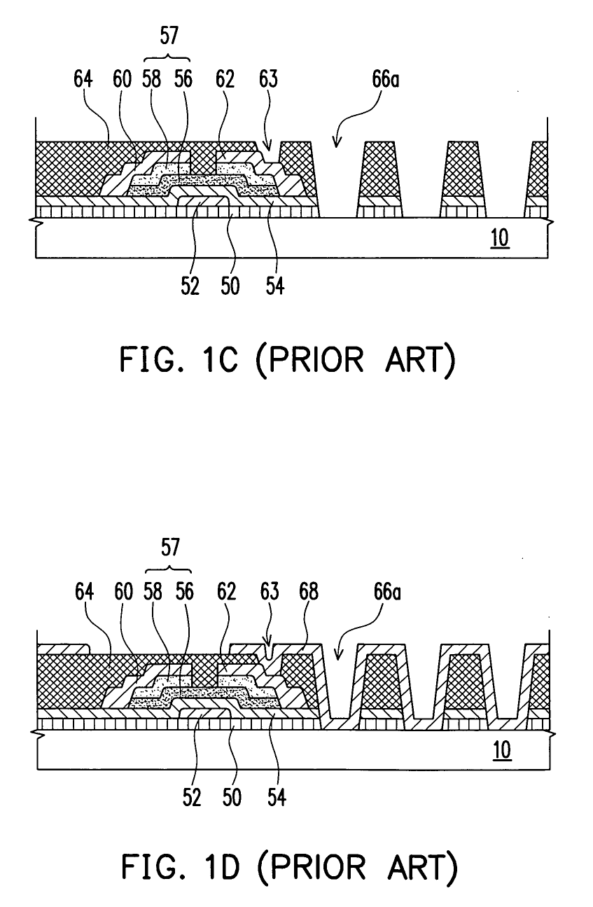

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

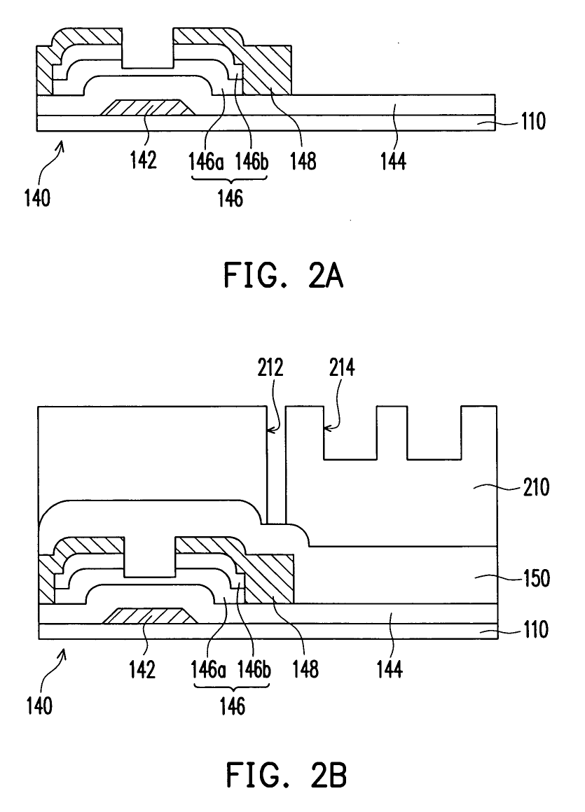

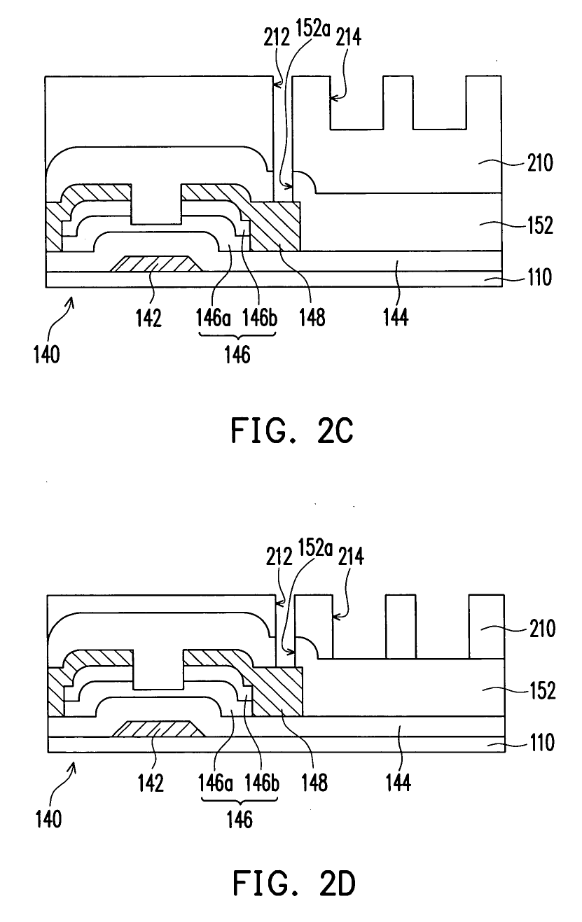

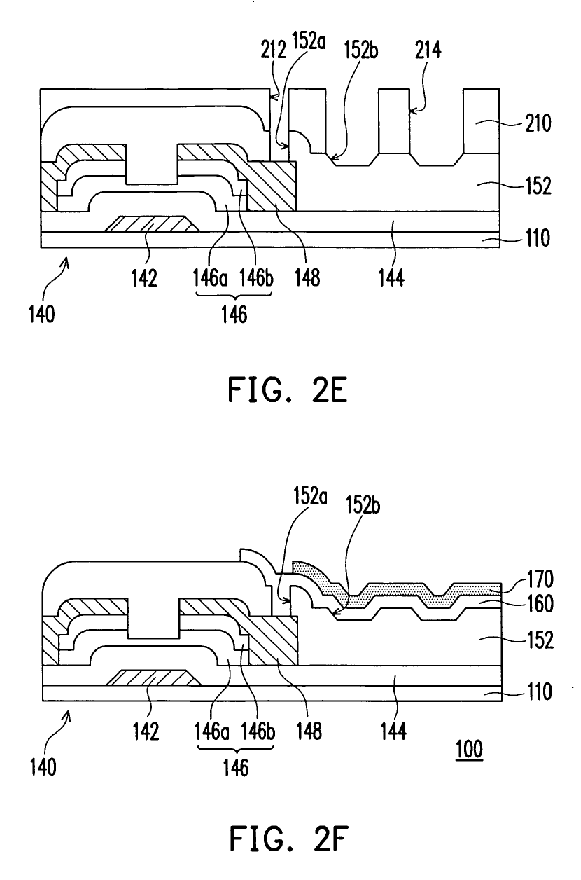

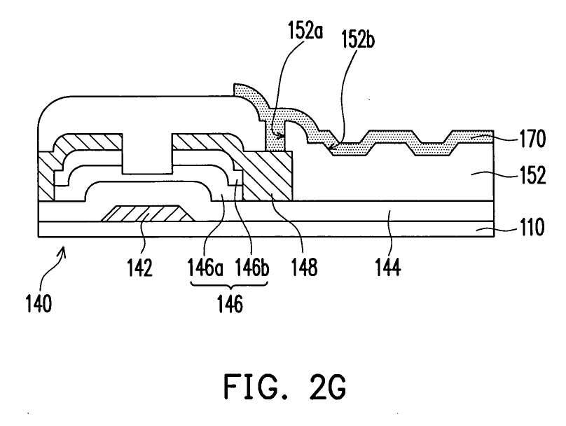

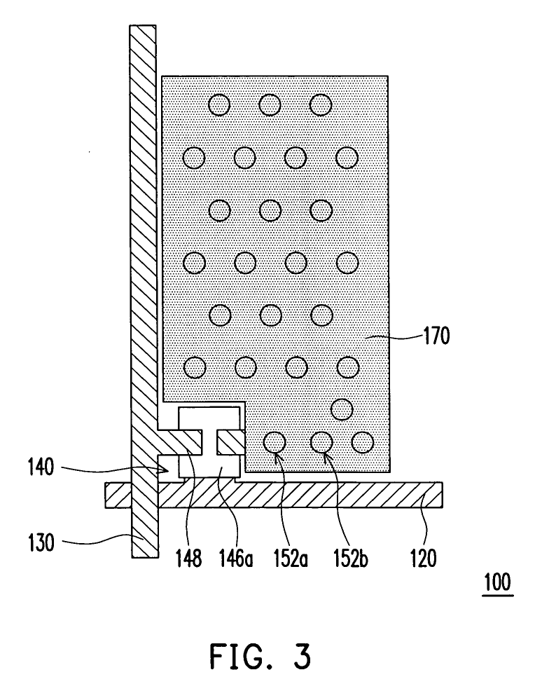

FIGS. 2A through 2F are schematic cross-sectional views showing tile method for fabricating a pixel structure according to a first embodiment of tile present invention. FIG. 2G is a schematic cross-sectional view showing another method of fabricating a pixel structure according to the first embodiment. FIG. 3 is a top view of pixel structure shown in FIG. 2F. As shown in FIG. 2A and 3, the method in the present invention is suitable for fabricating the pixel structure of a transflective liquid crystal display panel or a reflective liquid crystal display panel. In the present embodiment, the pixel structure of a reflective liquid crystal display panel is used as an example in the description. The method of fabricating the pixel structure includes the following steps. First, a substrate 110 is provided. The substrate 110 can be a glass substrate, a quartz substrate or a substrate in other configurations. Next, a scan line 120, a data line 130 and an active device 140 are formed over the substrate 110. The active device 140 is electrically connected to the scan line 120 and the data line 130. For example, the active device 140 can be a thin film transistor having a bottom gate, a thin film transistor having a top gate, a thin film transistor having a low-temperature polysilicon or other types of active devices. In the present embodiment, a thin film transistor having a bottom gate is used as an example of the active device in the description.

More specifically, a first conductive layer is formed on the substrate 110. Then, the first conductive layer is patterned to form a scan line 120 and a gate 142 connected to the scan line 120. Thereafter, a gate insulation layer 144 is formed on the substrate 10 to cover the gate 142. Then, a semiconductor layer 146 is formed on the gate insulation layer 144 above the gate 142. The semiconductor layer 146 comprises a channel layer 146a and an ohmic contact layer 146b disposed thereon. Next, a second conductive layer is formed over the substrate 110. The second conductive layer is patterned to form a data line 130 and a source/drain 148 connected to the data line 130. The source/drain 148 is disposed on the semiconductor layer 144 on the respective sides of the gate 142. After that, a portion of the ohmic contact layer 146b and the channel layer 146a, thereby completing the steps for fabricating the active device 140.

As shown in FIG. 2B, a dielectric layer 150 is formed over the substrate 110 to cover the active device 140 and the data line 130. In the present embodiment, the dielectric layer 150 can be a passivation layer. Then, a patterned photoresist layer 210 is formed on the dielectric layer 150. The patterned photoresist layer 210 has a first through hole 212 and a plurality of first recesses 214. The first through hole 212 exposes a portion of the dielectric layer 150. The method of forming the patterned photoresist layer 210 includes forming a photoresist material layer on the dielectric layer 150, and then an exposure process is performed to the photoresist material layer through a halftone mask. More specifically, the half tone mask comprises a transparent region, an opaque region and a semi-transparent region. The transparent region corresponds to the first through hole 212, the semi-transparent region corresponds to the first recesses 214. Because the semi-transparent region and the transparent region has different light transmission rates, the first through hole 212 and the first recesses 214 are formed in the patterned photoresist layer 210 after a develop process is performed.

As shown in FIGS. 2C through 2E, a portion of the dielectric layer 150 is removed using the patterned photoresist layer 210 as a mask to form a patterned dielectric layer 152. The patterned dielectric layer 152 has a second through hole 152a and a plurality of second recesses 152b . Furthermore, the second through hole 152a exposes a portion of the active device 140. Because the second through hole 152a exposes a portion of the active device 140, the second through hole 152a can be regarded as a contact hole.

More specifically, the method of forming the patterned dielectric layer 152 includes the following steps. First, a portion of the dielectric layer 150 is removed to form the second through hole 152a as shown in FIG. 2C. Next, a portion of the patterned photoresist layer 210 is removed so that the first recesses 214 expose the underlying dielectric layer 150 as shown in FIG. 2D. Thereafter, a portion of the dielectric layer 150 is removed to form the second recesses 152b as shown in FIG. 2E. In addition, the method of forming the second through hole 152a and the second recesses 152b may include performing a dry etching process or a wet etching process. In the present embodiment, the dry etching process is used. After that, the patterned photoresist layer 210 is removed.

As shown in FIGS. 2F and 3, a transparent conductive layer 160 is formed on the patterned dielectric layer 152. Tile transparent conductive layer 160 covers the second through hole 152a and the second recesses 152b. Hence, the transparent conductive layer 160 is electrically connected to the active device 140 through the second through hole 152. Furthermore, the transparent conductive layer 160 can be fabricated using indium tin oxide (ITO), indium zinc oxide (IZO), aluminum zinc oxide (AZO) or other transparent conductive materials. Next, a reflective layer 170 is formed on the transparent conductive layer 160. Tile reflective layer 170 covers at least the second recesses 152b. Moreover, the reflective layer 170 is electrically connected to the active device 140 through the transparent conductive layer 160. Up to this stage, the fabrication of the pixel structure 100 is mostly completed. The reflective layer 170 can be fabricated using aluminum, aluminum alloy, silver or other metal with a high reflectivity.

As shown in FIG. 2G, it is not limited to form the transparent conductive layer 160 and the reflective layer 170 in the present embodiment. It is feasible to form the reflective layer 170 alone. In this case, the reflective layer 170 should cover the second through hole 152a so that the reflective layer 170 can electrically connect with the active device 140 through the second through hole 152a.

In the present invention, the half-tone mask is used to form a patterned photoresist layer 210 with the first through hole 212 and the first recesses 214. Then, the patterned photoresist layer 210 is used as a mask in an etching process to form the second through hole 152a and the second recesses 152b. Hence, a good control on the depth and profile of the second recesses 152b can be obtained. In addition, method of fabricating the pixel structure in the present invention is compatible with the existing processes so that no extra equipment is required. Furthermore, compared with the conventional technique requiring an additional first insulation layer, there is no need to fabricate any extra film layers in the present invention for forming the pixel structure of a reflective liquid crystal display panel. Moreover, the depth of the second recesses 152b in the present invention is shallower than the conventional technique. Therefore, the reflective layer 170 will not be broken easily.

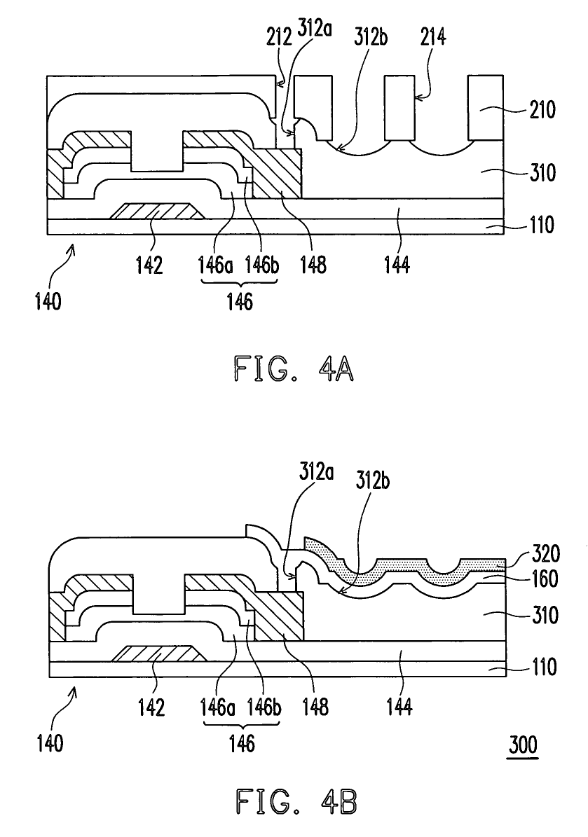

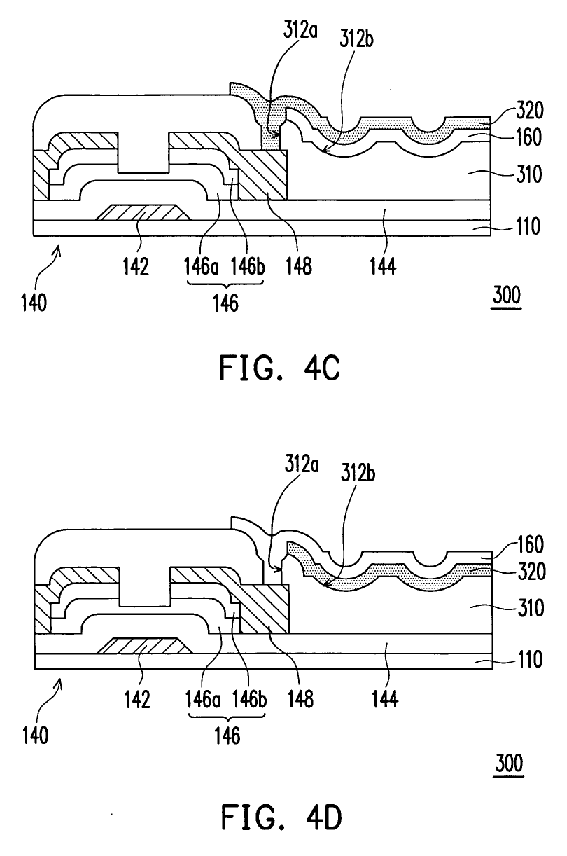

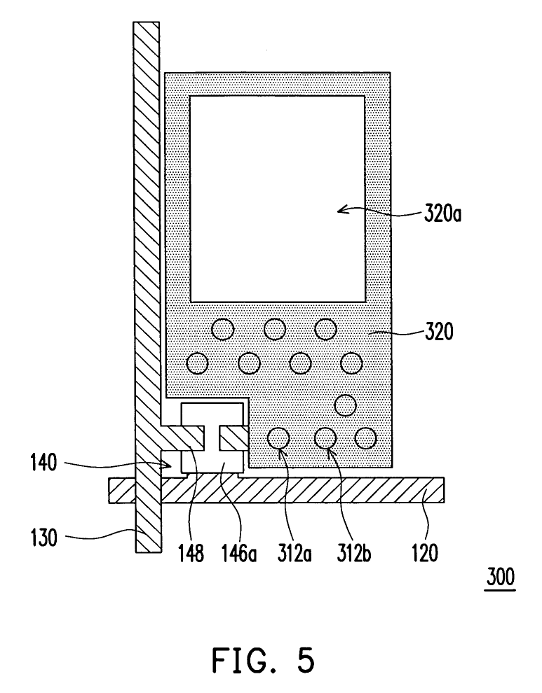

FIGS. 4A and 4B are schematic cross-sectional views showing the method for fabricating a pixel structure according to a second embodiment of the present invention. FIG. 5 is a top view of the pixel structure shown in FIG. 4B. FIGS. 4C and 4D are schematic cross-sectional views showing another method for fabricating a pixel structure according to the second embodiment of the present invention. As shown in FIGS. 4A and 5, the present embodiment is very similar to the aforementioned embodiment. One major different is that, in the present embodiment, the second through hole 312a and the second recesses 312b are fabricated by performing a wet etching process. Therefore, the second recesses 312b can have a hemispherical profile.

As shown in FIGS. 4B and 5, after removing the patterned photoresist layer 210, a transparent conductive layer 160 is formed on the patterned dielectric layer 310. The transparent conductive layer 160 covers the second through hole 312a and the second recesses 312b. Thus, the transparent conductive layer 160 is electrically connected to the active device 140 through the second through hole 312a. Thereafter, a reflective layer 320 is formed on the transparent conductive layer 160. The reflective layer 320 covers at least the second recesses 312b and has an opening 320a that exposes a portion of the transparent conductive layer 160. In other words, the opening 320a is also a transparent region. Because the pixel structure 300 can be divided into a reflective region and a transparent region, it can be used in a transflective liquid crystal display panel.

As shown in FIG. 4C, the reflective layer 320 can be electrically connected to the active device 140 directly through the second through hole 312a, and the transparent conductive layer 160 can be electrically connected to the active device 140 through the reflective layer 320.

As shown in FIG. 4D, there is no limitation on the formation sequence of the transparent conductive layer 160 and the reflective layer 320 in the present embodiment. Therefore, in another embodiment, the reflective layer 320 can be formed before the transparent conductive layer 160. Moreover, the transparent conductive layer 160 is electrically connected to the active device 140 through the second through hole 312a.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a pixel structure, comprising tile steps of:
providing a substrate;
forming a scan line, a data line and an active device over the substrate, wherein the active device is electrically connected to the scan line and the data line;
forming a dielectric layer over the substrate to cover the active device and the data line;
forming a patterned photoresist layer on the dielectric layer, wherein the patterned photoresist layer has a first through hole and a plurality of first recesses, and the first through hole exposes a portion of the dielectric layer;
removing a portion of the dielectric layer using the patterned photoresist layer as an etching mask to form a patterned dielectric layer, wherein the patterned dielectric layer has a second through hole and a plurality of second recesses, and the second through hole exposes a portion of the active device;
removing the patterned photoresist layer; and
forming a reflective layer on the patterned dielectric layer, wherein the reflective layer covers the second recesses and electrically connects to the active device.

2. The method of claim 1, wherein a half-tone mask is used in the process of forming the patterned photoresist layer.

3. The method of claim 1, wherein the step of removing a portion of the dielectric layer includes performing a dry etching or a wet etching process.

4. The method of claim 1, wherein the reflective layer also covers the second through hole and the reflective layer is electrically connected to the active device through the second through hole.

5. The method of claim 1, further includes a step of forming a transparent conductive layer on the patterned dielectric layer such that the transparent conductive layer covers the second through hole and the second recesses and the reflective layer is electrically connected to the active device through the transparent conductive electrode after the step of removing the patterned photoresist layer but before the step of forming the reflective layer.

6. The method of claim 5, wherein the reflective layer has an opening that exposes a portion of the transparent conductive layer.

7. The method of claim 1, further comprising a step of forming a transparent conductive layer on the patterned dielectric layer such that the transparent conductive layer is electrically connected to the active device through the reflective layer after the step of removing the patterned photoresist layer but before the step of forming the reflective layer.

8. The method of claim 7, wherein the reflective layer has an opening that exposes a portion of the transparent conductive layer.

9. The method of claim 1, further including a step of forming a transparent conductive layer on the reflective layer such that the transparent conductive layer covers the second through hole and the reflective layer is electrically connected to the active device through the transparent conductive layer after the step of forming the reflective layer.

10. The method of claim 9, wherein the reflective layer has an opening such that the transparent conductive layer covers the opening.

11. The method of claim 1, wherein the steps of forming the scan line, the data line and the active device include:
forming a scan line and a gate connected to the scan line on the substrate;
forming a gate insulation layer on the substrate to cover the gate;
forming a semiconductor layer on the gate insulation layer above the gate; and
forming a data line and a source/drain connected to the data line, wherein the source/drain is disposed on the semiconductor layer on each side of the gate such that the second through hole exposes a portion of tie source/drain.
